(19) United States
(12) Patent Application Publication
(10) Pub. No.: US 2017/0034138 A1
(43) Pub. Date: Feb. 2, 2017

(54) METHOD AND APPARATUS FOR WIRELESS VALIDATION

(71) Applicant: ECOLE POLYTECHNIQUE DE LAUSANNE (EPFL), Lausanne (CH)

(72) Inventors: Serge VAUDENAY, JR., Crissier (CH); Handan KILINC, Lausanne (CH)

(21) Appl. No.: 14/812,199

(22) Filed: Jul. 29, 2015

(51) Int. Cl. H04L 29/06; H04W 12/04

(52) U.S. Cl. CPC H04L 63/0435; H04L 63/0492; H04W 12/04

(57) ABSTRACT

A wireless validation method between an first apparatus and a second apparatus comprising the following steps of communicating between the first apparatus and the second apparatus for agreeing in a protected way on a common symmetric key and performing a symmetric distance bounding validation between the first apparatus and the second apparatus over a wireless communication link on the basis of the agreed common symmetric key.

### FIELD OF THE INVENTION

The present invention concerns an authentication method and system with distance control.

### DESCRIPTION OF RELATED ART

Several wireless payment systems such as toll payment systems and NFC credit cards have recently been spread. These methods allow to pay small amounts without any action from the holder (no confirmation, no PIN code) other than approaching their device to the payment terminal.

In relay attacks, a man-in-the-middle A passively relays messages between two participants: a prover P and a verifier V. The prover P is a credit card (of the payer) and the verifier V is a payment terminal (of the vendor). A can be run by two players: a malicious customer A1 mimicking a payment in a shop to buy some service to V, and a malicious neighbor A2 to the victim P. A1 and A2 relay messages between P and V. The payer may remain clueless.

So far, the most promising technique to defeat relay attacks is distance-bounding (DB) as for example introduced in S. Brands, D. Chaum. Distance-Bounding Protocols (Extended Abstract). In Advances in Cryptology EUROCRYPT'93, Lofthus, Norway, Lecture Notes in Computer Science 765, pp. 344-359, Springer-Verlag, 1994 (abrev. Brands-Chaum protocol). A DB protocol has several fast challenge/response rounds during which the verifier/vendor V sends a challenge bit and expects to receive a response bit within a very short time from the prover/payer P. The protocol fails if some response arrives too late or is incorrect. Due to the time of flight, if P is too far from V, his time to compute the response is already over when the challenge reaches him. Here are the traditional threat models for DB:
Honest-prover security: man-in-the-middle attacks (MiM) (including impersonation fraud and the so-called mafia fraud including relay attacks).
Malicious-prover security: distance fraud (DF), in which a far-away malicious prover pretends that he is close; distance hijacking (DH), in which the malicious prover relies on honest close-by participants; collusion frauds (CF) (including the so-called terrorist fraud), in which a malicious prover colludes with closeby participants (but without leaking credentials).
Privacy, where we want that no man-in-the-middle adversary can learn the identity of the prover. Wide/narrow privacy refers to whether the adversary can see if a protocol succeeds on the verifier side. Strong/weak privacy refers to whether the adversary can corrupt provers and get their secret.

DB protocols can be categorized as symmetric DB protocols and public key DB protocols. The verifier and the prover share a secret in symmetric DB protocols. The verifier only knows the public key of the prover in public key DB protocols. Public key DB protocols require much more power consumption and complexity at the prover P than symmetric DB protocols. This is due to the complex asymmetric encryption algorithms necessary for transmitting data. However, in some application, we cannot assume that prover and verifier share a secret, i.e. a symmetric key.

For payment systems, we cannot assume an online connection to a trusted server nor a shared secret between the payer and the vendor: we must have a public-key based protocol. We can further wonder which threat models are relevant. Clearly, the man-in-the-middle attacks are the main concern. Privacy is also important as payers want to remain anonymous to observers. For undeniability, a malicious payer shall not do a distance fraud then deny having made a payment on the basis that he was too far. Distance fraud shall also be prevented to be able to catch red handed people who pay with a stolen credit card.

Not many public-key DB protocols exist: the Brands-Chaum protocol mentioned above, the DBPK-Log protocol (L. Bussard, W. Bagga. Distance-Bounding Proof of Knowledge to Avoid Real-Time Attacks. In IFIP TC11 International Conference on Information Security SEC'05, Chiba, Japan, pp. 223-238, Springer, 2005), the protocol by Hermans, Peeters, and Onete (J. Hermans, R. Peeters, C. Onete. Efficient, Secure, Private Distance Bounding without Key Updates. In ACM Conference on Security and Privacy in Wireless and Mobile Networks WISEC'13, Budapest, Hungary, pp. 195-206, ACM, 2013) (herein called the HPO protocol), its recent extension by Gambs, Onete, and Robert (S. Gambs, C. Onete, J.-M. Robert. Prover Anonymous and Deniable Distance-Bounding Authentication. In ACM Symposium on Information, Computer and Communications Security (ASIACCS'14), Kyoto, Japan, pp. 501-506, ACM Press, 2014) (the GOR protocol, herein), and ProProx (S. Vaudenay. Proof of Proximity of Knowledge. IACR Eprint 2014/695 report, 2014). FIG. 1 shows the security of those protocols against the described attacks. None except ProProx resist to collusion frauds (CF). The Brands-Chaum protocol does not resist to distance hijacking (DH). DBPK-Log could not be proven safe against any attack. Neither the Brands-Chaum protocol nor ProProx protect privacy, but the HPO and GOR protocols were designed for this. However, HPO does not offer strong privacy and privacy in GOR can be broken.

Therefore, it is an object to provide a light and power efficient wireless validation protocol which is secure against most of the above-mentioned attacks and which can be used in applications not having a shared secret between the Prover P and the Verifier V.

### BRIEF SUMMARY OF THE INVENTION

According to the invention, these aims are achieved by combining a protected key agreement protocol for agreeing on a common symmetric key between the Prover and the Verifier with a symmetric distance-bounding protocol using the agreed common symmetric key.

This solution has the advantage of combining the efficient and light structure of symmetric DB protocols with the necessary privacy by agreeing in a protected way on the symmetric key used for symmetric DB protocol.

### BRIEF DESCRIPTION OF THE DRAWINGS

The invention will be better understood with the aid of the description of an embodiment given by way of example and illustrated by the figures, in which:

FIG. 1 shows a table with the security of wireless validation methods of the prior art and a first embodiment of the wireless validation method;

FIG. 2 shows the wireless validation method;

FIG. 3 shows a first embodiment of the wireless validation method between a verifier and a prover;

FIG. 4 shows a key agreement step of a second embodiment of the wireless validation method between a verifier and a prover;

FIG. 5 shows an example key agreement step of the second embodiment of the wireless validation method between a verifier and a prover;

FIG. 6 shows a second embodiment of the wireless validation method between a verifier and a prover; and

FIG. 7 shows an example of the symmetric DB validation step of the wireless validation method between a verifier and a prover.

### DETAILED DESCRIPTION OF POSSIBLE EMBODIMENTS OF THE INVENTION

The wireless validation protocol is configured to provide at a verifier V a wireless validation of a prover P. A validation could be the basis for the allowance of an action of the prover P, e.g. the payment of a certain amount of money from the prover P to the verifier V. In order to perform the wireless validation method, an apparatus of the prover P communicates with an apparatus of the verifier V. In the following, the apparatus of the prover P is for the sake of brevity abbreviated as the prover P and the apparatus of the verifier V is abbreviated for the sake of brevity by the verifier V. The apparatus of the verifier V could be a computer, a payment terminal, a smartphone, mobile telephone, a chip, a tablet or any other apparatus with the ability to exchange wireless messages with the prover P over a wireless communication link and to compute the necessary steps of the wireless validation method at the verifier V. The apparatus of the prover P could be a computer, a payment chip card, a smartphone, mobile telephone, a tablet, a chip or any other apparatus with the ability to exchange wireless messages with the verifier V over the wireless communication link and to compute the necessary steps of the wireless validation method at the at the prover P. In one embodiment, the prover P is realized by an RFID-chip. In one embodiment, the wireless communication link is a radio communication, but also other wireless communication links like optical or ultrasound communication links are possible. In one embodiment, the wireless communication link is a near field communication (NFC). An important application of this wireless validation method is the payment over NFC. However, also other applications of this wireless validation methods are possible, in particular for application where the verifier V and the prover P have no common secret.

FIG. 2 shows an embodiment the wireless validation method. The wireless validation method comprises the step S1 of agreeing between the verifier V and the prover P in a protected way on a common symmetric key s. In a subsequent step S2, a symmetric DB validation is performed on the basis of the agreed common symmetric key.

In step S1, the verifier V and the prover P communicate with each other over the wireless communication link in order to agree on the common symmetric key to be used for step S2. The communication is protected such that a third person could not determine the common symmetric key by intercepting the messages between the verifier V and the prover P. In one embodiment, this is achieved by providing a key pair, including a public key and a secret key (also called private key) corresponding to the public key, at at least one of the prover P and the verifier V. The key pair is preferably at least the prover P. The key pair is used to agree on the common symmetric key s in a protected way.

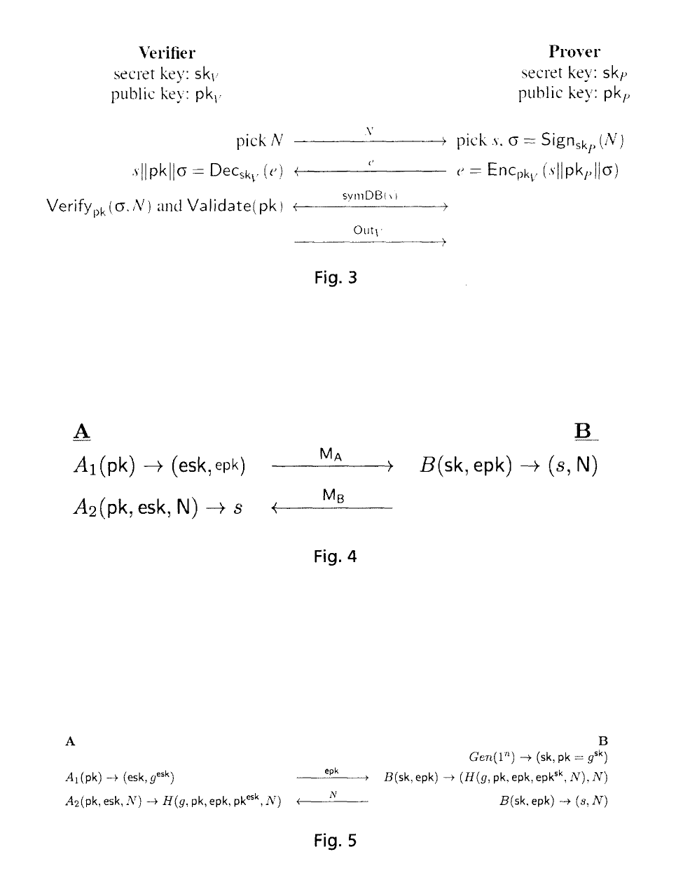

FIG. 3 shows an embodiment for the wireless validation method with a protected key agreement based on a key pair at the prover P and at the verifier V. The verifier has a secret key sk_{V} and a public key pk_{V}. The prover P has a secret key sk_{P} and a public key pk_{P}. A symmetric key s is created by one of the verifier V and the prover P and sent to the other of the verifier V and the prover P encrypted by public key of the other of the verifier V and the prover P and signed by the private/secret key of the one of the verifier V and the prover P. This can be done as explained in more detail in the following.

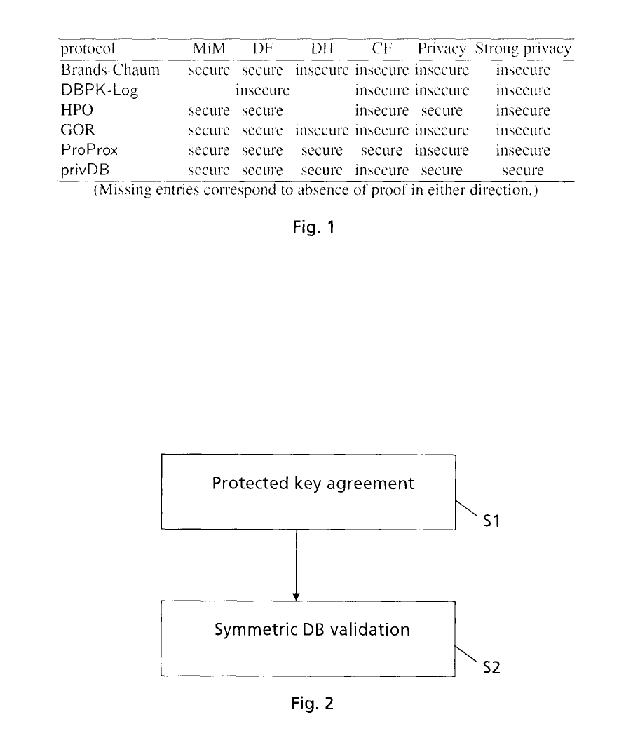

In a not shown initialization phase, the verifier V sends over the communication link his public key pk_{V} to the prover P. Alternatively, the verifier V could already possess the public key pk_{V} or receive it from a third party, maybe a central server. The verifier picks a random number N and sends this random number N to the prover P. The prover P creates a signature σ on the basis of the random number N and the private key sk_{P} of the prover P and picks a symmetric key s. This symmetric key is like a symmetric session key for the symmetric DB process in step S2. The symmetric key s could be picked as any random number. The prover P creates the reply message e to the verifier V by encrypting a combination s∥pk_{P}∥σ of the symmetric key s, the public key pk_{P} of the prover P and the signature σ on the basis of the public key pk_{V} of the verifier V. The combination could be a simple concatenation. The prover P sends the reply message e to the verifier V which decrypts e on the basis of the private key sk_{V} of the verifier V. The verifier V determines from the combination s∥pk_{P}∥σ the symmetric key s, the public key pk_{P} of the prover P and the signature σ. The verifier V can then verify the signature σ on the basis of N and the public key pk_{P} of the prover P. If the verification is successful, the verifier V knows that the reply comes from the prover P and can trust the received symmetric key s. The roles of P and V in the key agreement step S1 could also be exchanged, but the shown embodiment has the advantage that the public key pk_{P} of the prover P is never sent unencrypted over the communication link. Even if the used encryption and signature steps at the prover P are much more efficient and less power consuming than the known public key DB protocols, they nevertheless provide a certain computational burden due to assymetric encryption, decryption and signature steps. In addition, present payment terminals often do not have any key pair available. FIG. 1 shows that this wireless validation method called here privDB is secure against MiM, DF, DH and each kind of privacy attacks.

FIG. 4 shows an alternative embodiment for the protected key agreement step S1. Herein a semi-authenticated key agreement (S-AKA) protocol is used for exchanging the key. In a S-AKA protocol the one party B of two parties A and B generate a secret key pair with a public key pk and a corresponding secrete/private key sk. A knows the public key pk of B beforehand. This can be realized by exchanging the public key over the communication link. A calculates an ephemeral key pair with a ephemeral public key epk and an ephemeral secret key esk. This is preferably done on the basis of the public key pk of the one party B. A sends a message M_{A} with the ephemeral public key epk over the communication link to B. B calculates the key s on the basis of the secret key sk, the ephemeral public key epk and a nonce N picked by B. B sends a message MB with the nonce N to A. Also A can know calculate the key s on the basis of the public key, the ephemeral secret key and the nonce N.

FIG. 5 shows an example for an S-AKA protocol called Nonce-Diffie-Hellman key agreement protocol. Herein, the public key pk is g power the secret key sk: pk=g^{sk}. Here g is preferably a generator of a prime order q group. g and q depend on the security level. g is known by A beforehand or is exchanged with the public key pk. The key s is calculated at B by a hash function H(g, pk, epk, epk^{sk}, N) of the argument which combine, e.g. concatenates, g, pk, epk, epks^{k}, N. The key s is calculated by A by a hash function H(g, pk, epk, pk^{esk}, N) of the argument combined/concatenated by g, pk, epk, pk^{esk}, N. Since epk^{sk}=pk^{esk}, both hash functions at A and B result the same value. The common key s can be determined based on this hash function result.

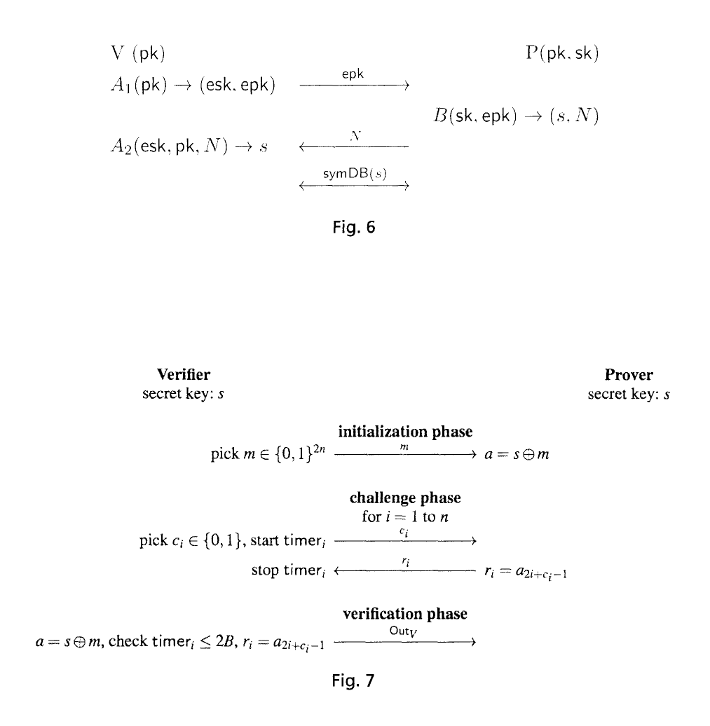

FIG. 6 shows now the complete embodiment of the wireless validation method with an S-AKA protocol as key agreement step S1. In the shown embodiment, the prover P takes the role of party B and the verifier V takes the role of party A. The worst computational steps of the prover P are thus the power and the hash function which are both computational efficient functions. Therefore, this embodiment shows a very light wireless validation method.

The second step S2 can be any symmetric DB validation step using the symmetric key s agreed in step S1. In one embodiment, for each symmetric DB validation step, a new symmetric key s is agreed between the verifier V and the prover P in step S1.

FIG. 7 shows an example for a symmetric DB validation step which is a one time distance bounding (OTDB) validation. The symmetric key s is a 2n-bit key. The verifier XORs the key s with a random mask m selected by the verifier V. The mask m should have the same length 2n as the key s. The verifier V sends then m to the prover P which performs as well a=s XOR m. Then the verifier V sends n binary challenges to the prover P. A binary challenge cᵢ is 1 or 0 for all i=1, . . . n. Each challenge cᵢ is selected at the verifier V normally randomly. The prover P answers to each challenge on the basis the combination a of s and m. In this case, the prover P replies on the binary challenge cᵢ being 1 or 0 with rᵢ=a_{2*i+c-1} which is the bit of a at the position 2i−1 or 2i, depending on the challenge cᵢ. The verifier V verifies the correct replies rᵢ for all I on the basis of a and checks, if the travel time tᵢ between each challenge cᵢ and its corresponding reply rᵢ at the verifier V is smaller than a threshold (here 2B).

1. A wireless validation method between an first apparatus and a second apparatus comprising the following steps:
communicating between the first apparatus and the second apparatus for agreeing in a protected way on a common symmetric key;
performing a symmetric distance bounding validation between the first apparatus and the second apparatus over a wireless communication link on the basis of the agreed common symmetric key.

2. The method according to claim 1, wherein the second apparatus comprises a secret key and a public key, wherein the step of communicating between the first apparatus and the second apparatus for agreeing on the common symmetric key comprises the step of providing the first apparatus with the public key of the second apparatus and agreeing on the common symmetric key on the basis of public key and the private key of the second apparatus.

3. The method according to claim 1, wherein the first apparatus comprises a secret key and a public key and the second apparatus comprises a secret key and a public key, wherein the common symmetric key is created by the second apparatus, which is sent to the first apparatus encrypted by public key of the first apparatus with a signature performed by the secret key of the second apparatus.

4. The method according to claim 3, wherein the signature is calculated on the basis of a random number received from the first apparatus.

5. The method according to claim 3, wherein the first apparatus decrypts the common symmetric key on the basis of the private key of the first apparatus and checks the validity of the signature on the basis of the public key of the second apparatus and the random number.

6. The method according to claim 1, wherein the step of communicating between the first apparatus and the second apparatus for agreeing on the common symmetric key comprises a semi-authenticated key agreement step.

7. The method according to claim 1, wherein the second apparatus comprises or generates a secret key and a public key, wherein the step of communicating between the first apparatus and the second apparatus for agreeing on the common symmetric key comprises the steps of:
providing the first apparatus with the public key of the second apparatus,
creating at the first apparatus an ephemeral public key and an ephemeral secret key on the basis of the public key of the second apparatus,
sending the ephemeral public key and the ephemeral secret key to the second apparatus,
calculating the common symmetric key on the basis of the secret key of the second apparatus, the ephemeral public key of the first apparatus and a nonce,
sending the nonce from the second apparatus to the first apparatus, and
calculating the common symmetric key on the basis of the ephemeral secret key of the first apparatus, the public key of the second apparatus and the nonce received from the second apparatus.

8. The method according to claim 7, wherein the common symmetric key at the first apparatus is calculated on the basis of a hash function based on the ephemeral secret key of the first apparatus, the public key of the second apparatus and the nonce received from the second apparatus and the common symmetric key at the second apparatus is calculated on the basis of the hash function based on the secret key of the second apparatus, the ephemeral public key of the first apparatus and a nonce.

9. The method according to claim 7, wherein the public key of the second apparatus is a base number power the secret key of the second apparatus, wherein the ephemeral public key is the base number power the ephemeral secret key, wherein the common symmetric key at the first apparatus is calculated on the basis of the hash function based on the public key of the second apparatus power the ephemeral secret key of the first apparatus, and the common symmetric key at the second apparatus is calculated on the basis of the hash function based on the ephemeral public key of the first apparatus power the secret key of the second apparatus.

10. The method according to claim 1, wherein for each symmetric distance bounding validation a new common symmetric key is agreed.

11. The method according to claim 1, wherein the step of performing a symmetric distance bounding validation comprises:
sending a number of challenges from the first apparatus to the second apparatus;
replying on each challenge with a reply based on the corresponding challenge and the agreed common symmetric key;
checking at the first apparatus for each received response the time delay between the corresponding challenge sent and the response received and checking on the basis of the corresponding challenge sent and the agreed common symmetric key, if the received response is correct.

12. A wireless validation method of a first apparatus with respect to a second apparatus comprising the following steps:
communicating with the second apparatus for agreeing in a protected way on a common symmetric key;
performing a symmetric distance bounding validation with the second apparatus over a wireless communication link on the basis of the agreed common symmetric key.

13. The method according to claim 12, wherein the first apparatus comprises an own secret key and an own public key, wherein the first apparatus possesses or receives a public key of the second apparatus, wherein the common symmetric key is decrypted on the basis of the own secret key from an encrypted message received from the second apparatus and a signature of the encrypted message is checked on the basis of the public key of the second apparatus and a nonce sent to the second apparatus.

14. The method according to claim 12, wherein the first apparatus comprises an own secret key and an own public key, wherein the first apparatus possesses or receives a public key of the second apparatus, wherein the common symmetric key is created and encrypted in a message on the basis of the public key of the second apparatus with a signature created based on a nonce received from the second apparatus and based on the own secret key.

15. The method according to claim 12, wherein the step of communicating with the second apparatus for agreeing on the common symmetric key comprises the steps of:
possessing or receiving at the first apparatus the public key of the second apparatus,
creating an ephemeral public key and an ephemeral secret key on the basis of the public key of the second apparatus,
sending the ephemeral public key and the ephemeral secret key to the second apparatus,
receiving a nonce from the second apparatus, and
calculating the common symmetric key on the basis of the ephemeral secret key of the first apparatus, the public key of the second apparatus and the nonce received from the second apparatus.

16. The method according to claim 12, wherein the first apparatus comprises or generates an own secret key and an own public key, wherein the step of communicating with the second apparatus for agreeing on the common symmetric key comprises the steps of:
receiving an ephemeral public key created on the basis of the public key from the second apparatus,
calculating the common symmetric key on the basis of the own secret key, the ephemeral public key of the second apparatus and a nonce, and
sending the nonce to the second apparatus.

17. A first apparatus configured for
communicating with a second apparatus for agreeing in a protected way on a common symmetric key; and
performing a symmetric distance bounding validation with the second apparatus over a wireless communication link on the basis of the agreed common symmetric key.

18. The apparatus according to claim 17, wherein the first apparatus comprises an own secret key and an own public key, wherein the first apparatus possesses or receives a public key of the second apparatus, wherein the first apparatus is configured for decrypting the common symmetric key on the basis of the own secret key from an encrypted message received from the second apparatus and checking a signature of the encrypted message on the basis of the public key of the second apparatus and a nonce sent to the second apparatus.

19. The apparatus according to claim 17, wherein the first apparatus comprises an own secret key and an own public key, wherein the first apparatus possesses or receives a public key of the second apparatus, wherein the first apparatus is configured for creating the common symmetric key and sending the common symmetric key and a signature in a message encrypted on the basis of the public key of the second apparatus to the second apparatus, wherein the signature is created based on a nonce received from the second apparatus and based on the own secret key.

20. The apparatus according to claim 17, wherein the first apparatus is configured for:
possessing or receiving at the first apparatus the public key of the second apparatus,
creating an ephemeral public key and an ephemeral secret key on the basis of the public key of the second apparatus,
sending the ephemeral public key and the ephemeral secret key to the second apparatus,
receiving a nonce from the second apparatus, and
calculating the common symmetric key on the basis of the ephemeral secret key of the first apparatus, the public key of the second apparatus and the nonce received from the second apparatus.

21. The apparatus according to claim 17, wherein the first apparatus comprises or generates an own secret key and an own public key, wherein the first apparatus is configured for:
receiving an ephemeral public key created on the basis of the public key from the second apparatus,
calculating the common symmetric key on the basis of the own secret key, the ephemeral public key of the second apparatus and a nonce, and
sending the nonce to the second apparatus

22. The apparatus according to claim 17, wherein the first apparatus is a payment terminal configured to permit a payment after successful symmetric distance bounding validation.

23. Computer program configured to perform the following step, when executed on a processor:
communicating with an apparatus for agreeing in a protected way on a common symmetric key; and
performing a symmetric distance bounding validation with the apparatus over a wireless communication link on the basis of the agreed common symmetric key.
